(19) United States
(12) Patent Application Publication
(10) Pub. No.: US 2019/0346737 A1
(43) Pub. Date: Nov. 14, 2019

(54) SUPERCONTINUUM COHERENT LIGHT SOURCE

(71) Applicant: INSTITUTE OF PHYSICS, CHINESE ACADEMY OF SCIENCES, Beijing (CN)

(72) Inventors: KUN ZHAO, Beijing (CN); ZHIYI WEI, Beijing (CN); YANGYANG LIU, Beijing (CN); PENG HE, Beijing (CN); PEI HUANG, Beijing (CN); HANGDONG HUANG, Beijing (CN); XINKUI HE, Beijing (CN); HAO TENG, Beijing (CN)

(21) Appl. No.: 16/331,351

(22) PCT Filed: Aug. 30, 2017
(86) PCT No.: PCT/CN2017/099557

§ 371 Date: Mar. 7, 2019

(30) Foreign Application Priority Data
Sep. 8, 2016 (CN) 201610808917.3

(51) Int. Cl. G02F 1/35; G02F 1/365; G02F 1/355; G02B 5/08; H01S 3/11; H01S 3/067

(52) U.S. Cl. CPC G02F 1/3501; G02F 1/365; G02F 1/355; G02F 2001/3528; H01S 3/11; H01S 3/067; G02F 2001/3503; G02B 5/08

(57) ABSTRACT

The present invention provides a supercontinuum coherent light source, comprising: a laser generation device configured to generate a laser pulse having a peak optical intensity at a beam waist of the laser pulse being 0.47-0.94×10¹³ W/cm²; and, a set of solid thin plates configured to spectrally broaden the laser pulse to generate a supercontinuous spectrum. The supercontinuum coherent light source of the present invention has an efficiency of up to 87% and the spectrum is broadened to more than one octave.

### CROSS REFERENCE TO RELATED APPLICATIONS

This application is a National Stage of PCT Application No. PCT/CN2017/099557 filed on Aug. 30, 2017, which claims priority to Chinese Patent Application No. 201610808917.3 filed on Sep. 8, 2016, the contents each of which are incorporated herein by reference thereto.

### TECHNICAL FIELD

The present invention belongs to the technical field of optical physics, in particular to a supercontinuum coherent light source based on solid thin plates.

### BACKGROUND OF THE PRESENT INVENTION

Supercontinuum and ultra-broadband coherent light sources, particularly light sources having a spectral width of up to or more than one octave, are widely applied in many fields including compression to generate few-cycle to single-cycle femtosecond pulses, measuring and locking carrier-envelope phase of femtosecond laser pulses, generation of higher order harmonics and attosecond laser pulses in a gas target, tunable light sources, laser spectroscopy and so on.

At present, the most commonly used method for generating supercontinuum and ultra-broadband coherent light is to broaden the spectrum by using a gas-filled hollow-core fiber and to compress pulses by using a wedge pair and chirped mirrors. The light beam obtained by this method is good in quality, and the spectrum broadening effect is significant. However, one fatal defect of this method is that the core diameter of the hollow fiber cannot be too large. For a large-aperture fiber, due to the loss of the waveguide effect, the output beam profile will be poor. However, the fact that the core diameter cannot be too large means that the input pulse energy that can be received by the hollow fiber cannot exceed a certain threshold. In addition, since the core diameter of the fiber is of a submillimeter order, the pointing stability of the incident light is required to be very good, and a slight deviation or jitter in the pointing direction of the incident light will strongly affect the spectrum and energy of the output pulse and the beam quality of the output. Finally, the transmission of the gas-filled hollow-core fiber generally can reach 50% only, so the energy loss is relatively high. Therefore, it is necessary to develop a new method for generating supercontinuum and ultra-broadband coherent light with high energy.

Recently, it has been found that the supercontinuum and ultra-broadband coherent light source can be realized by use of solid material instead of the gas-filled hollow-core fiber. However, at present, for ultra-broadband continuous spectrum coherent light source that is generated by using solid material and has a spectral width of up to or more than one octave, the output energy is still very low, less than 0.1 mJ, and the efficiency is also very low. Such light sources with high output energy have a wider range of application.

### SUMMARY OF THE PRESENT INVENTION

Hence, an objective of the present invention is to overcome the deficiencies of the prior art and provide a supercontinuum coherent light source, including:

a laser generation device configured to generate a laser pulse having a peak optical intensity at the beam waist of 0.47-0.94×10¹³ W/cm²; and

a set of solid thin plates configured to spectrally broaden the laser pulse to generate a supercontinuous spectrum.

According to the supercontinuum coherent light source of the present invention, preferably, the laser generation device includes a femtosecond laser and a beam shaping unit configured to adjust the peak optical intensity of the laser pulse generated by the femtosecond laser. The femtosecond laser is preferably a Ti:Sapphire femtosecond laser.

According to the supercontinuum coherent light source of the present invention, preferably, the set of solid thin plates contains N solid thin plates, where N≥5.

According to the supercontinuum coherent light source of the present invention, preferably, the solid thin plates are made of fused silica, calcium fluoride, yttrium aluminum garnet, sapphire crystal or silicon carbide.

According to the supercontinuum coherent light source of the present invention, preferably, the solid thin plates each have a thickness of 10 to 500 μm.

According to the supercontinuum coherent light source of the present invention, preferably, the first solid thin plate in the set of solid thin plates is placed before the beam waist of the laser pulse, and the second to N^{th} solid thin plates form a quasiperiodic structure.

According to the supercontinuum coherent light source of the present invention, preferably, the set of solid thin plates contains 7 solid sheets.

According to the supercontinuum coherent light source of the present invention, preferably, the peak optical intensity at the beam waist of the laser pulse is 0.94×10¹³ W/cm², and the spacings between two adjacent solid thin plates from the first solid thin plate to the seventh solid thin plate are 20 cm, 8.5 cm, 4.5 cm, 5 cm, 5 cm and 5 cm, in turn.

According to the supercontinuum coherent light source of the present invention, preferably, the peak optical intensity at the beam waist of the laser pulse is 0.69×10¹³ W/cm², and the spacings between two adjacent solid thin plates from the first solid thin plate to the seventh solid thin plate are 5.5 cm, 4 cm, 3 cm, 3 cm, 2 cm and 2 cm, in turn.

According to the supercontinuum coherent light source of the present invention, preferably, the peak optical intensity at the beam waist of the laser pulse is 0.47×10¹³ W/cm², and the spacings between two adjacent solid thin plates from the first solid thin plate to the seventh solid thin plate are 12 cm, 8.5 cm, 4.5 cm, 5 cm, 5 cm and 5 cm, in turn.

The present invention further provides a method for generating a supercontinuous coherent spectrum, including the following steps of:

step 1: generating a laser pulse by using a laser generation device, the peak optical intensity at a beam waist of the laser pulse being 0.47-0.94×10¹³ W/cm²; and

step 2: spectrally broadening, by using a set of solid thin plates, the laser pulse to generate a supercontinuous spectrum.

Compared with the prior art, in the supercontinuum coherent light source of the present invention, by using a femtosecond laser and a set of solid thin plates and by properly adjusting the optical output intensity of the femtosecond laser and the position and spacing of the set of solid thin plates, a supercontinuous spectrum can be realized at a higher power and a higher efficiency, and the spectrum is broadened to one octave.

### BRIEF DESCRIPTION OF THE DRAWINGS

The embodiments of the present invention will be further described below with reference to the accompanying drawings, in which:

FIG. 1 is a schematic diagram of an optical path of a supercontinuum coherent light source based on solid thin plates according to an embodiment of the present invention;

FIG. 2 shows a curve of a supercontinuum output from a set of solid thin plates according to an embodiment of the present invention;

FIG. 3 shows curves of a spectrum and a spectral phase measured by TG-FROG according to an embodiment of the present invention; and

FIG. 4 shows curves of the pulse width and temporal phase measured by TG-FROG according to an embodiment of the present invention.

### DETAILED DESCRIPTION OF THE PRESENT INVENTION

To make the objectives, technical solutions and advantages of the present invention clearer, the present invention will be further described below in detail by way of specific embodiments with reference to the accompanying drawings. It should be understood that the specific embodiments described herein are merely for explaining the present invention, rather than limiting the present invention.

### Embodiment 1

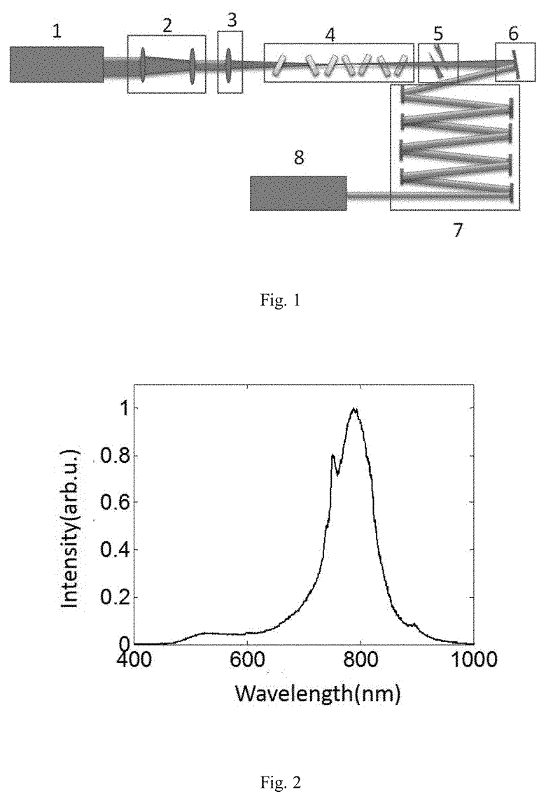

FIG. 1 shows a schematic diagram of an optical path of a supercontinuum coherent light source based on solid thin plates according to an embodiment of the present invention. The supercontinuum coherent light source includes:

a Ti:sapphire femtosecond laser 1, with a model of FEMTOPOWER COMPACT PRO, configured to generate a collimated laser beam having a central wavelength of 790 nm, a pulse width of about 30 fs, a repetition frequency of 1 kHz, a single pulse energy of 0.8 mJ and a beam diameter of 12 mm;

an optical telescope unit (a beam shrinking system) 2 configured to shrink the femtosecond laser beam at a beam shrinking ratio of 3:1;

an optical focusing unit (a convex lens) 3 having a focal length f=2000 mm, wherein, after the shrinked femtosecond laser beam is focused by the optical focusing unit 3, the diameter of the obtained beam waist is about 600 μm and the peak intensity at the focus is about 0.94×10¹³ W/cm²; and

a set of solid thin plates 4, which contains 7 fused silica plates each having a thickness of 0.1 mm and configured to generate a supercontinuous spectrum. The focused femtosecond laser beam is directly injected into the set of solid thin plates 4. Due to the self-phase modulation effect, the spectrum will be broadened. The fused silica thin plates are preferably arranged at the Brewster's angle in order to reduce the interface reflection loss. With respect to the position of the focus of the laser beam without the set of thin plates, the first fused silica thin plates is placed 31 cm before the focus, and the remaining plates are 20 cm, 8.5 cm, 4.5 cm, 5 cm, 5 cm and 5 cm away from the previous plate, respectively. Therefore, the last six fused silica thin plates form a quasiperiodic structure. The last five sheets almost form a strict periodic structure. Meanwhile, the diameter of light spots on the first four plates is about 400 μm, and the diameter of light spots on the fifth, sixth and seventh plates is gradually increased to 500 μm, 600 μm and 800 μm, respectively. In this case, the beam divergence is much less than that of the light beam generated without the set of thin plates. Therefore, the seven fused silica thin plates also form a quasi-waveguide structure. The purpose of such an arrangement is to achieve the best spectrum broadening effect while avoiding the occurrence of the filamentation in the thin plates and the air and medium damage in the thin plates due to the excessive self-focusing of the light beam, and at the same time reduce the energy loss caused by multiphoton processes. The energy of the pulse after passing through the set of solid thin plates 4 is 0.7 mJ. The overall transmission of the set of solid thin plates is up to 87%, and the output supercontinuous spectrum covers 460 nm to 950 nm (at −20 dB of the peak intensity). Specifically, FIG. 2 shows a curve of the supercontinuous spectrum output from the set of solid thin plates 4.

The supercontinuum coherent light source further includes a dispersion adjustment unit (a wedge pair) 5 configured to finely adjust the dispersion to achieve the best compression effect of the final output ultra-short pulse; it is also possible to use a single or a plurality of fused silica plates with a proper thickness to adjust the dispersion to achieve the same adjustment effect as the wedge pair;

an optical collimation unit (a concave reflector) 6, which has a focus length f=2000 mm and configured to collimate the light beam;

a compressor (a chirped mirror set) 7 configured to compensate the dispersion. When the input pulse successively passes through each optical unit including the set of solid thin plates 4 during propagation, material dispersion is introduced by each transmission element, and dispersion is also introduced by the nonlinear optical process of the set of thin plates; the chirped mirror set 7 consists of 4 pairs of chirped mirrors (8 mirrors), each pair can provide a second-order dispersion of about −90 fs² to compensate for the previously accumulated dispersion; and, the pulse energy measured after the chirped mirror set is 0.68 mJ; and

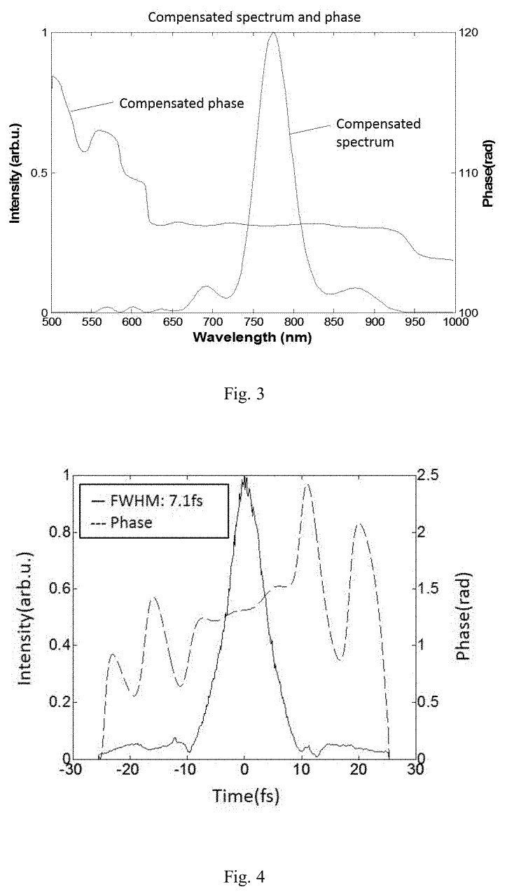

a spectrometer and pulse width measurement device 8. In this embodiment, the spectral curve of the output pulse is directly measured by a spectrometer (Ocean Optics HR2000+), and the pulse width is measured by TG-FROG (transient-grating frequency resolved optical gating. The device obtains a frequency-resolved optical gating (FROG) trace by using the transient grating-induced change in spectrum with the optical path difference generated by the nonlinear optical effect. The spectrum and spectral phase of the pulse can be obtained by performing an inversion operation on the spectrogram. Referring to FIG. 3, FIG. 3 shows curves of the spectrum and spectral phase measured by the TG-FROG, wherein the spectral range is about 650 nm to 930 nm, which is narrower than the spectral range of 460 nm to 950 nm directly measured by the spectrometer. Meanwhile, it can be known from the phase curve that the region with relatively flat phase is about 620 nm to 930 nm. By considering the above two points, it can be concluded that in the experiments, due to the limited bandwidth of the chirped mirrors used for dispersion compensation, effective compensation is achieved only between 620 nm and 930 nm, which is consistent with the parameters of the chirped mirrors. This is why the pulse is compressed to 7.1 femtoseconds. If chirped mirrors with a larger bandwidth are used, it is possible to compress the pulse shorter. The dispersion of the pulse can be calculated from the phase, and the electric field and phase of the pulse in the time domain can be calculated by Fourier transformation, thus obtaining the pulse width. Referring to FIG. 4, FIG. 4 shows the curve of the pulse width measured by the TG-FROG. The results show that the compressed pulse width is 7.1 fs. In FIG. 4, the solid line represents the time-domain light intensity, and the dashed line represents the time-domain phase. The full width at half maximum (FWHM) of the curve of the time-domain light intensity is the pulse width.

In this embodiment, the Ti:sapphire femtosecond laser 1, the optical telescope unit (beam shrinking system) 2 and the optical focusing unit (convex lens) 3 can be combined to form a laser generation unit for generating a laser beam having a peak optical intensity of 0.94×10¹³ W/cm².

### Embodiment 2

The supercontinuum coherent light source in Embodiment 2 has the same structure as that in Embodiment 1, except that the output pulse energy of the Ti:sapphire femtosecond laser 1 is adjusted as 0.2 mJ, and a long focus lens with f=2.5 m is used to focus the laser beam to the focus with a spot diameter of about 350 μm. Then, seven fused silica thin plates each having a thickness of 0.1 mm are placed in the vicinity of the focus. The peak intensity at the focus is about 0.69×10¹³ W/cm². The distance from the first thin plate to the last thin plate is less than 20 cm, and the spacings between adjacent plates are about 5.5 cm, 4 cm, 3 cm, 3 cm, 2 cm and 2 cm, respectively. A supercontinuous spectrum of 0.18 mJ is output. The overall transmission of the set of solid thin plates is 90%. The output spectrum is consistent with the spectrum shown in FIG. 2.

### Embodiment 3

In Embodiment 3, the input pulse energy is increased to 0.4 mJ, the laser is shrinked at a beam shrinking ratio of 3:1, and the focused laser spot is enlarged to a diameter of about 600 μm by a lens with f=2 m. Then, seven fused silica thin plates each having a thickness of 0.1 mm are placed in the vicinity of the focus. The peak intensity at the focus is about 0.47×10¹³ W/cm². The spacing between the first thin plate and the last thin plate is about 40 cm, and the spacings between the thin plates are basically the same as those in Embodiment 1 except that the spacing between the first and second plates is about 12 cm. The overall transmission is about 88%. The output spectrum is consistent with the spectrum shown in FIG. 2.

### Embodiment 4

Embodiment 4 provides a method for generating a supercontinuous spectrum, including the following steps:

step 1: generating, by using a femtosecond laser source, a collimated laser pulse having a peak optical intensity of 0.47-0.94×10¹³ W/cm²;

step 2: spectrally broadening, by using a set of solid thin plates, the collimated laser pulse obtained in the step 1 to obtain a supercontinuous spectrum having a width of more than one octave;

step 3: finely adjusting, by using a dispersion adjustment unit, the dispersion of the supercontinuous spectrum obtained in the step 2;

step 4: collimating, by using an optical collimation unit, the light beam obtained in the step 3; and

step 5: performing, by a compressor, dispersion compensation for the light beam obtained in the step 4 to eventually obtain a few-cycle femtosecond pulse having a spectrum of more than one octave.

According to other embodiments of the present invention, by adjusting the spacings between the seven fused silica thin plates, the generation of the supercontinuous spectrum having an adjustable injection energy from 0.4 mJ to 0.8 mJ is realized. When the injection energy is 0.4 mJ, the distance between the first thin plate and the last thin plate is about 40 cm. When the injection energy is 0.8 mJ, the distance between the first thin plate and the last thin plate is about 50 cm. When the injection energy is different, the supercontinuous spectrum with better light spots can be generated by roughly adjusting the position of the first thin plate and finely adjusting the other thin plates. At the injection energy of 0.4-0.8 mJ, the generation efficiency of the supercontinuous spectrum is greater than 85%; the output spectrum covers 460 nm to 950 nm, which reaches one octave; and the output spectrum is consistent with the spectrum shown in FIG. 2.

According to other embodiments of the present invention, the transmission of the set of solid thin plates is directly related to the optical intensity of the input light. The lower the optical intensity is, the weaker the multiphoton absorption and ionization effects are, and the lower the energy loss is. In addition, low optical intensity will result in less spectral broadening through each thin plate, which requires an increase in the number of solid thin plates to compensate for the required spectrum broadening. In an embodiment the present invention, the number of solid thin plates is correspondingly adjusted according to the intensity of the incident light.

In addition, it should be easily understood by those skilled in the art that, in order to make the peak optical intensity at the beam waist of the incident light to be within a range of 0.47-0.94×10¹³ W/cm², it is possible to directly use a laser having an output peak intensity of 0.47-0.94×10¹³ W/cm², or it is also possible to use other known optical devices in the art to convert the intensity so as to realize the required peak optical intensity.

According to other embodiments of the present invention, the light source may be a femtosecond laser source having a pulse width of 10-2000 femtoseconds.

According to other embodiments of the present invention, the optical telescope unit and the optical focusing unit are combined to form a beam shaping unit for shaping the laser beam emitted from the femtosecond laser source so as to obtain a laser beam having a desired peak optical intensity.

It should be understood by those skilled in the art that, when a laser beam passes through a blocky solid material, the self-focusing effect accompanying with the self-phase modulation will cause beam collapse, and the intensity rises rapidly, resulting in a large amount of multiphoton adsorption and ionization. As a result, filamentation and medium damage are caused, and the light beam is completely destroyed. This phenomenon can be avoided by using a thin piece of material. Although the self-phase modulation produced by each thin plate can only slightly broaden the spectrum, a set of thin plates having an appropriate spacing between plates can prevent the occurrence of filamentation and damage and also obtain a supercontinuous spectrum similar to that of the gas-filled hollow-core fiber. According to other embodiments of the present invention, the number of thin plates in the set of solid thin plates is greater than or equal to 5, and the thin plates can be made of calcium fluoride, yttrium aluminum garnet, sapphire crystal, silicon carbide or other materials and each have a thickness of 10-500 μm.

According to other embodiments of the present invention, the first solid thin plate is placed before a geometrical focus of the focusing lens, in order to achieve the maximum spectrum broadening while using an optical path as short as possible. In addition to participation in spectrum broadening, this solid thin plate further shapes the light beam after the beam shrinking and focusing elements. By adjusting the position of this solid thin plate, the laser can be incident on the subsequent solid thin plates at the optimal light spot size and divergence angle. The subsequent solid thin plates form a quasiperiodic structure for realizing quasi-waveguide restriction, which is similar to the waveguide effect, of the laser beam, so that an effective spectrum broadening is realized by self-phase modulation, and the balance between the self-phase modulation and the self-focusing is realized. Accordingly, the best spectrum broadening effect is achieved.

Although the present invention has been described by the preferred embodiments, the present invention is not limited to the described embodiments. Various alterations and changes made without departing from the scope of the present invention shall be included.

1. A supercontinuum coherent light source, comprising:
a laser generation device configured to generate a laser pulse having a peak optical intensity at a beam waist of the laser pulse of 0.47-0.94×10¹³ W/cm²; and
a set of solid thin plates configured to spectrally broaden the laser pulse to generate a supercontinuous spectrum.

2. The supercontinuum coherent light source according to claim 1, wherein the laser generation device comprises a femtosecond laser and a beam shaping unit configured to adjust the peak optical intensity of the laser pulse generated by the femtosecond laser.

3. The supercontinuum coherent light source according to claim 1, wherein the set of solid thin plates contains N solid thin plates, where N≥5.

4. The supercontinuum coherent light source according to claim 1, wherein the solid thin plates are made of fused silica, calcium fluoride, yttrium aluminum garnet, sapphire crystal or silicon carbide.

5. The supercontinuum coherent light source according to claim 1, wherein the solid thin plates each have a thickness of 10 to 500 μm.

6. The supercontinuum coherent light source according to claim 1, wherein the first solid thin plate in the set of solid thin plates is placed before the beam waist of the laser pulse, and the second to N^{th} solid thin plates form a quasiperiodic structure.

7. The supercontinuum coherent light source according to claim 6, wherein N=7, the peak optical intensity at the beam waist of the laser pulse is 0.94×10¹³ W/cm², and the spacings between two adjacent solid thin plates from the first solid thin plate to the seventh solid thin plate are 20 cm, 8.5 cm, 4.5 cm, 5 cm, 5 cm and 5 cm, in turn.

8. The supercontinuum coherent light source according to claim 6, wherein N=7, the peak optical intensity at the beam waist of the laser pulse is 0.69×10¹³ W/cm², and the spacings between two adjacent solid thin plates from the first solid thin plate to the seventh solid thin plate are 5.5 cm, 4 cm, 3 cm, 3 cm, 2 cm and 2 cm, in turn.

9. The supercontinuum coherent light source according to claim 6, wherein N=7, the peak optical intensity at the beam waist of the laser pulse is 0.47×10¹³ W/cm², and the spacings between two adjacent solid thin plates from the first solid thin plate to the seventh solid thin plate are 12 cm, 8.5 cm, 4.5 cm, 5 cm, 5 cm and 5 cm, in turn.

10. A method for generating a supercontinuous coherent spectrum, comprising the following steps:
step 1: generating a laser pulse by using a laser generation device, the peak optical intensity at a beam waist of the laser pulse being 0.47-0.94×10¹³ W/cm²; and
step 2: spectrally broaden, by using a set of solid thin plates, the laser pulse to generate a supercontinuous spectrum.

11. The supercontinuum coherent light source according to claim 2, wherein the set of solid thin plates contains N solid thin plates, where N≥5.

12. The supercontinuum coherent light source according to claim 2, wherein the solid thin plates are made of fused silica, calcium fluoride, yttrium aluminum garnet, sapphire crystal or silicon carbide.

13. The supercontinuum coherent light source according to claim 2, wherein the solid thin plates each have a thickness of 10 to 500 μm.

14. The supercontinuum coherent light source according to claim 2, wherein the first solid thin plate in the set of solid thin plates is placed before the beam waist of the laser pulse, and the second to N^{th} solid thin plates form a quasiperiodic structure.

15. The supercontinuum coherent light source according to claim 14, wherein N=7, the peak optical intensity at the beam waist of the laser pulse is 0.94×10¹³ W/cm², and the spacings between two adjacent solid thin plates from the first solid thin plate to the seventh solid thin plate are 20 cm, 8.5 cm, 4.5 cm, 5 cm, 5 cm and 5 cm, in turn.

16. The supercontinuum coherent light source according to claim 14, wherein N=7, the peak optical intensity at the beam waist of the laser pulse is 0.69×10¹³ W/cm², and the spacings between two adjacent solid thin plates from the first solid thin plate to the seventh solid thin plate are 5.5 cm, 4 cm, 3 cm, 3 cm, 2 cm and 2 cm, in turn.

17. The supercontinuum coherent light source according to claim 14, wherein N=7, the peak optical intensity at the beam waist of the laser pulse is 0.47×10¹³ W/cm², and the spacings between two adjacent solid thin plates from the first solid thin plate to the seventh solid thin plate are 12 cm, 8.5 cm, 4.5 cm, 5 cm, 5 cm and 5 cm, in turn.
